(19) United States
(12) Patent Application Publication
(10) Pub. No.: US 2021/0109597 A1
(43) Pub. Date: Apr. 15, 2021

(54) SYSTEM AND METHOD FOR RECOGNIZING GESTURES THROUGH MULTI-POINT FORCE DISTRIBUTION CHANGE MAP

(71) Applicant: ZHENGWEI ZHAI, Qujing City (CN)

(72) Inventor: ZHENGWEI ZHAI, Qujing City (CN)

(21) Appl. No.: 16/600,290

(22) Filed: Oct. 11, 2019

(51) Int. Cl. G06F 3/01

(52) U.S. Cl. CPC G06F 3/017; G06F 3/014

(57) ABSTRACT

A method for recognizing gestures through an electric device including at least one force-sensing garment, the force-sensing garment including multiple discrete force-sensing points, wherein the method includes donning the at least one force-sensing garment on a body part; gesturing with the body part covered by some force-sensing points; detecting a normal force exerted on each force-sensing point at different points in time; generating at least one multi-point force distribution change map based on detected force distribution of at least two different points in time; if the generated multi-point force distribution change map corresponds to a predefined multi-point force distribution change map of a gesture, the electric device generates instructions representing or based on the gesture.

### FIELD OF THE INVENTION

The present invention generally relates to an electric device with at least one force-sensing garment and a method for recognizing gestures or user identity through multi-point force distribution change map and further generating gesture-based or gesture-and-motion-based instructions.

### BACKGROUND OF THE INVENTION

The following background information may present examples of specific aspects of the prior art, U.S. Pat. No. 8,046,721 B2 (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, an input device is a piece of computer hardware equipment used to provide data and control signals to an information processing system such as a computer or information appliance. Examples of input devices include keyboard, mouse, scanner, touchscreen, digital camera, and joystick.

Switches and buttons are used to control disconnection or connection of circuits. They have two states, on and off, which correspond to 0 and 1 signals in computer operations. Knobs and dials in an electric device are also switches, but they have more functions than switches and buttons. For example, except the two states of switches and buttons, on and off, different levels of electric current can be used to perform more functions, and the increase of electric current by knobs or dials can be used to increase the volume of music, vice versa, and their states can be expressed as 0, 1, 1+, 1++, 1+++, etcetera.

Each key of a computer keyboard is essentially an independent switch with a default state of disconnection. When a user presses a key, a circuit is connected and output a relevant signal or data. A computer keyboard is equivalent to a combination of buttons or switches arranged in a user-friendly layout. Similarly, a typical mouse is a combination of a two-dimensional plane position tracking device (optical or laser sensor), two keys (left key, right key) and a knob (roller).

Various icons of a graphical user interface are simulations of physical keys by software programs. When a user clicks an icon by a mouse, a program runs specific commands corresponding to the icon. The process and function are similar to press physical buttons or keys, so icons, in some cases, are called virtual keys. Except for traditional keys' functions, various icons of software applications are also some combinations of pixels in a range of a screen. It is also known that if each pixel in an icon is regarded as a separate virtual key, the icon can be considered as a combination of virtual keys performing the same kind of functions.

The problems of the devices mentioned above or user interfaces are that their operational efficiency for inputting complex instruction is very low, and it is easy to cause RIS (Repetitive Strain Injury) for long-term users.

Interfaces with a computer using gestures of a human body, typically hand movement, have provided a more nature and intuitive method for users. However, most gestures recognition methods and systems are based on images captured by camera(s) and computer vision algorithm(s). They need body part(s) for gesturing stay in camera field and require high data process capacity. Once the operating environment changes, gesture recognition accuracy and capacity may decrease a lot. For example, longer distance of body part to the camera and darker background may cause huge gesture recognition errors. For these reasons, the camera-based gesture recognition method and system cannot provide fast, accurate gesture recognition results, and they also cannot further provide accurate and fast gesture-based input and control instructions either. Accordingly, there is a need for a non-camera-based gesture recognition method and device with high recognition accuracy and great recognition capacity. Besides, a more versatile gesture-based instruction or gesture-and-motion-based instruction method and device are desirable. In some cases, a user identity may also need to be recognized without a camera.

### SUMMARY

Illustrative embodiments of the disclosure are generally directed to an electric device and a method for recognizing gestures, recognizing user identity, generating gesture-based or gesture-and-motion-based instructions. The electric device includes at least one force-sensing garment that is donned on one or more body parts such as fingers, hands, wrists, legs, feet, or other body parts of a user. The force-sensing garment comprises multiple discrete force-sensing points designed to detect a normal force exerted on each force-sensing point. During a process of gesturing, the normal force exerted on each force-sensing point may be changed and detected. The detected force data of individual force-sensing point corresponding to at least two points in time are used to generate a multi-point force distribution change map for recognizing gestures or user identity, and generating gesture-based instructions. The electric device may further include a position tracking device for detecting positions or motions of a body part, and one or more programs further generate instructions based recognized gesture and detected motion.

The process of recognizing gestures includes steps of donning a force-sensing garment on a body part, gesturing with a body part, detecting force distribution changes caused by gesturing over time and recognizing the gesture of the body part by analyzing a multi-point force distribution change map. The process of recognizing user identity is like the process of recognizing gesture through a multi-point force distribution change map.

The process for generating gesture-based instructions includes steps of recognizing a gesture and gesture-related features, steps of converting the recognized gesture and gesture-related features into gesture-based instructions, wherein the gesture-based instructions are defined by gesture parameters, body part parameter, and at least one other gesture-related feature parameter.

The process for generating gesture-and-motion-based instructions includes steps of recognizing a gesture and gesture-related features, steps detecting motions, and steps of converting recognized gesture, gesture-related features and motions into gesture-and-motion-based instructions. The gesture-and-motion-based instructions are generated based on at least four parameters including gesture parameter, body part parameter, at least one other gesture-related feature parameter and at least one motion parameter.

In another aspect, the force-sensing garment(s) may include one or more of the following: force-sensing gloves, force-sensing wrist bands, force-sensing jackets, force-sensing shoes, force-sensing socks, force-sensing pants, force-sensing thigh sleeves, any combination or any part of these force-sensing garments.

In another aspect, the body part(s) may include one or more of the following: finger, hand, arm, forearm, elbow, wrist, shoulder, back, waist, trunk, loin, hip, buttock, leg, foot, or any combination of these body parts.

One objective of the present invention is to provide a novel non-camera-based gesture or user identity recognition method and electric device with high recognition accuracy and great recognition;

Another objective of the present invention is to provide an easy-to-use gesture-based or gesture-and-motion-based interface and interaction method;

The other objectives of the present invention are to provide a type of versatile gesture-based or gesture-and-motion-based instructions;

Other systems, devices, methods, features, and advantages will be or become apparent to one with skills in the art upon examination of the following drawings and detailed descriptions. It is intended that all such additional devices, methods, features, and advantages are included within this description, are within the scope of the present disclosure, and are protected by the accompanying claims and drawings.

### BRIEF DESCRIPTION OF THE DRAWINGS

The invention will now be described, by way of example, with reference to the accompanying drawings, in which;

FIG. 1 illustrates a device configuration for recognizing gestures, user identity and generating gesture-based or gesture-and-motion-based instructions, in accordance with an embodiment of the present invention;

FIG. 2 illustrates views of some force-sensing garments, in accordance with an embodiment of the present invention;

FIG. 3 illustrates a body part donning a force-sensing glove comprising multiple force-sensing points and a multi-point force distribution change map, in accordance with an embodiment of the present invention;

FIG. 4 is a flow diagram illustrating a process for recognizing a gesture through a multi-point force distribution change map and further generating gesture-based instructions, in accordance with an embodiment of the present invention;

FIGS. 5A, 5B and 5C illustrate views of a force-sensing garment, a body part, and a multi-point force distribution change map in a user recognition mode, in accordance with an embodiment of the present invention;

FIG. 6 is a flow diagram illustrating a process for generating gesture-and-motion-based instructions, in accordance with an embodiment of the present invention;

FIGS. 7A and 7B illustrate an example of force distribution change on some regions of a force-sensing garment during a process of gesturing with a body part, in accordance with an embodiment of the present invention;

FIG. 8 illustrates a consistent one-to-one match relation between gesture, body part, contact area, and multi-point force distribution change map, in accordance with an embodiment of the present invention;

FIG. 9 illustrates a consistent one-to-one match relation between contact area, contact angle and multi-point force distribution change map, in accordance with an embodiment of the present invention;

FIGS. 10A and 10B illustrate examples of a user's gesture and rules of generating gesture-based instruction or gesture-and-motion-based instructions, in accordance with an embodiment of the present invention;

FIGS. 11A, 11B, 11C and 11D illustrate examples of gesture-and-motion-based instruction applications for painting and handwriting program, in accordance with an embodiment of the present invention;

Like reference numerals refer to like parts throughout the various views of the drawings.

### DETAILED DESCRIPTION OF THE INVENTION

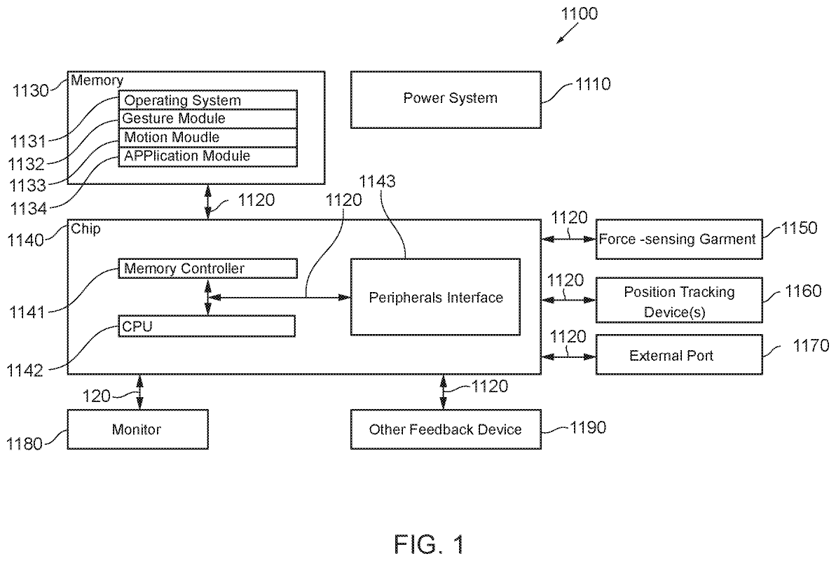

The following detailed description is merely exemplary and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary and provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, summary, or the following detailed descriptions. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

FIGS. 1-11 illustrates an electric device 1100 and method for recognizing gestures, recognizing user identity, and generating gesture-based or gesture-and-motion-based instructions, in accordance with some embodiments of the present invention. The device 1100 and method are unique for recognizing gestures or user identity through a multi-point force distribution change map. The device 1100 and method are effective in that it can recognize gestures or user identity with high accuracy and great capacity, and further provide numerous gesture-based or gesture-and-motion-based instructions by some simple gestures.

FIG. 1 illustrates a device 1100 which comprises a power system 1110, a memory 1130, a memory controller 1141, one or more processing units (CPU's) 1142, a peripheral interface 1143 and a force-sensing garment 1150. These components communicate over one or more communication buses or signal lines 1120.

The device 1100 may be any portable or nonportable electronic device, including but not limited to a smartphone, a desktop computer, a control center for one or more devices, an input device or the like, or a combination of two or more of these devices.

The power system 1110 for powering various components may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The memory 1130 may include a high-speed random-access memory, one or more flash memory devices, one or more magnetic disk storage devices, or other memory devices. In some embodiments, the memory 1130 may further include a storage remotely located from the one or more processors 1142, such as a network-attached storage which can be accessed via wireless communication network or flash drive via external port 1170. Access to the memory 1130 by other components of the device 1100, such as the CPU 1142 and the peripheral interface 1143, may be controlled by the memory controller 1141.

The peripheral interface 1143 couples the force-sensing garment 1150 and other input or output peripherals of the device to the CPU 1142 and the memory 1130. The one or more processors 1142 run various software programs and/or sets of instructions stored in the memory 1130 to perform various functions for the device 1100 and to process data. In some embodiments, the peripheral interface 1143, the CPU 1142, and the memory controller 1141 may be implemented on a single chip, such as a chip 1140. In some other embodiments, they may be implemented on separate chips.

The force-sensing garment 1150 provides a gesture interface between a user and the device 1100. The force-sensing garment 1150 is designed to convert the process of gesturing into the change of exerted the normal force on each force-sensing point over time. For the convenience of explanation, hereafter the normal force exerted on each force-sensing point is called “force distribution,” and the change of exerted the normal force on each force-sensing point, caused by gesturing over time, is called “multi-point force distribution change map.” The force-sensing garment 1150 is wearable or attachable to a body part and comprises multiple discrete force-sensing points. In some embodiments, the multiple discrete force-sensing points comprises at least fifty discrete force-sensing points. The force-sensing garment is operatively connected to, or comprises electrical circuitry, an information processing device, or a storage device. The force-sensing garment detects and transforms the normal force into measurable electrical output signals, and the measurable electrical output signals are further converted into force data and transmitted to the peripheral interface 1143 for processing. The force data may also be retrieved from and/or transmitted to the memory 1130 by the peripheral interface 1143.

Preferably, the discrete force-sensing points 108a-c comprises at least fifty discrete force-sensing points.

In some embodiments, the intensity of force-sensing points of a force-sensing garment 1150 is up to 248 sensels per cm². In some other embodiments, the force-sensing point intensity of a force-sensing garment may be higher.

In some embodiments, the force-sensing garment detects the normal force utilizing one or more of the following: piezoelectric film, force-sensitive electrical resistance sensor, force-sensitive graphene, force-sensitive electronic skin, or pressure sensor. However, the force-sensing garment may also detect the normal force by other force-sensing technologies not yet developed as of the filing date of this document.

In some embodiments, the force-sensing garment 1150 includes one or more force-sensing gloves. However, in other embodiments, the force-sensing garment 1150 may include one or more force-sensing wrist bands, force-sensing jacket, force-sensing shoes, force-sensing socks, force-sensing pants, force-sensing thigh sleeves, or one or more portions or combinations of these force-sensing garments.

In some embodiments, the software components include an operating system 1131, a gesture module (or set of instructions) 1132, and one or more applications (or set of instructions) 1134. The operating system 1131 includes various software components and/or drivers for controlling and managing general system tasks (e.g., memory management, storage device control, power management, etc.) and facilitating communication between various hardware and software components.

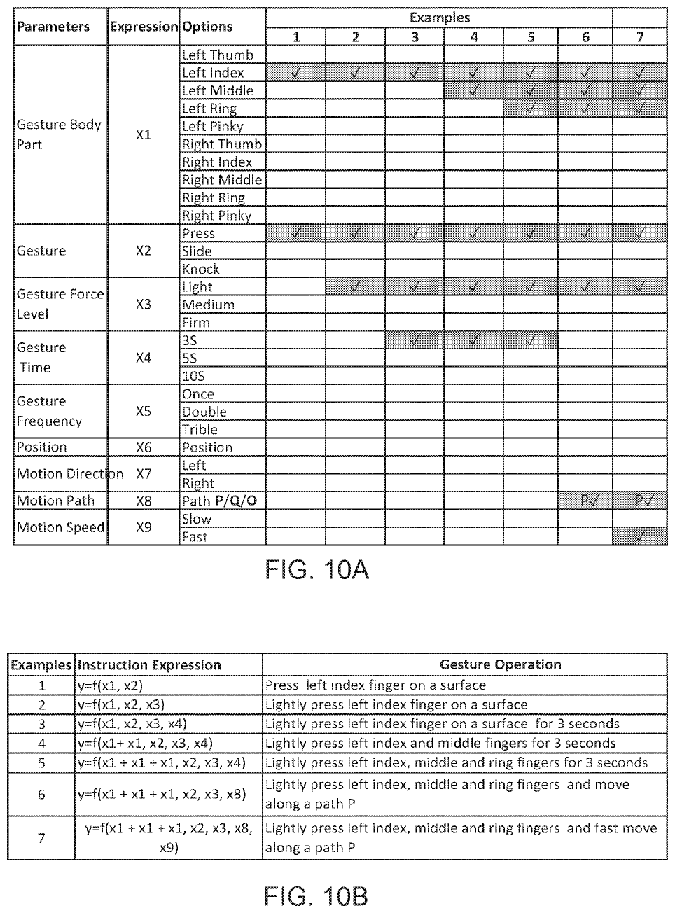

The gesture module 1132 includes various software components to process the force distribution data for recognizing gestures, recognizing gesture-related features, or converting the recognized gestures or gesture-related features into values of parameters of gesture-based instructions. More details for the gesture-related features are illustrated in the description of FIG. 3 and FIG. 10.

The one or more applications 1134 may include one or more gesture-based or gesture-and-motion-based applications installed on the device 1100, including without limitation, applications for data input, drawing, painting, user identity recognition, designing, word processing, game playing, music playing, or interaction objects control or management.

In some embodiments, the device 1100 may further include a position tracking device 1160 and a motion module (or set of instructions) 1133, The position tracking device 1160 detects the position or motion of a gesture body part. The motion module 1133 includes various software components for performing various operations related to detect, record, and convert the position or motion of the gesture body part into values of one or more motion parameters of gesture-and-motion-based instructions.

In some embodiments, the position tracking device 1160 is a plane position tracking device including one or more touch panel, optical or laser motion sensors. Though in other embodiments, the position tracking device 1160 may be one or more three-dimensional position/motion tracking devices including one or more gyroscopes or accelerators. The position tracking device 1160 may be integrated with the force-sensing garment 1150 or be separated from the force-sensing garment 1150.

In some embodiments, the device 1100 may further include a monitor 1180 for providing visual output or feedback to a user.

In some embodiments, the device 1100 may further include one or more other feedback devices 1190 to provide auditory or tactile feedback.

It should be appreciated that the device 1100 is only one example of the electronic device including a force-sensing garment 1150, and that the device 1100 may have more or fewer components than shown or a different configuration of components. The various components shown in FIG. 1 may be implemented in hardware, software or a combination of both hardware and software, including one or more signal processing and/or applications specific integrated circuits.

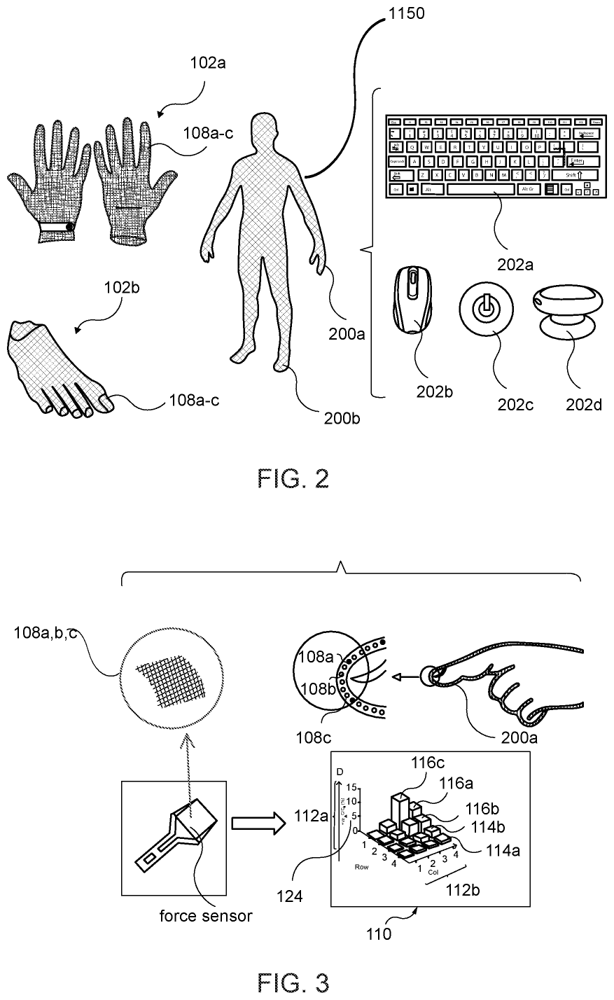

FIG. 2 illustrates some exemplary force-sensing garments 1150, in accordance with an embodiment of the present invention. Both the force-sensing gloves 102a and socks 102b in FIG. 2 are exemplary force-sensing garments 1150. The force-sensing gloves 102a are wearable to a user's hands 200a, and the force-sensing socks 102b are wearable to the user's feet 200b. Both the force-sensing gloves 102a and force-sensing socks 102b comprise multiple discrete force-sensing points 108a-c. Preferably, the discrete force-sensing points 108a-c comprise at least fifty discrete force-sensing points 108a-c. The force-sensing gloves 102a or socks 102b convert a process of gesturing into a multi-point force distribution change map. The multi-point force distribution change map is analyzed by an algorithm or compared to predefined multi-point force distribution change maps to recognize the gesture. In some embodiments, the multi-point force distribution change map may further be converted into gesture-based instructions.

In some embodiments, the device 1100 including the force-sensing gloves 102a may perform functions of input or control devices like keyboard 202a, mouse 202b, knob 202c, and dial 202d.

In some embodiments, the force-sensing garment 1150 may include one or more force-sensing wrist bands, force-sensing jacket, force-sensing shoes, force-sensing socks, force-sensing pants, force-sensing thigh sleeves, or one or more portions or combinations of these force-sensing garments. Accordingly, in these embodiments, the gesture body part may include, without limitation, one or two hands 200a, one or two feet 200b, one or two arms, one or two forearms, one or two elbows, one or two wrists, one or two legs, or one or more portions of a body part such as one or more fingers of a hand 200a, or a combination of some body parts. Myriad combinations of force-sensing garment 1500 and body part(s) may be used, based on the instruction needs and the gesture capacity of the body part(s).

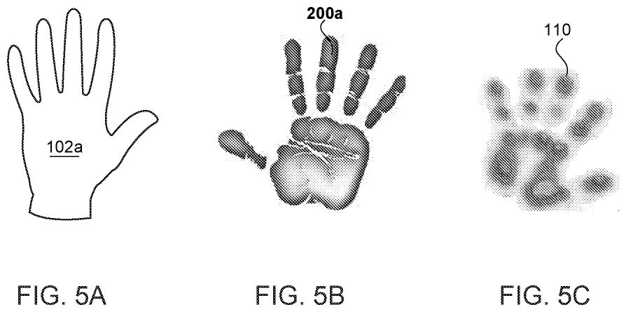

Turning now to FIG. 3, a force-sensing glove 102a converts a process of gesturing into a multi-point force distribution change map. When a user dons a force-sensing glove 102a and performs a gesture, the force-sensing glove 102a detects force distribution at different points in time, then a program or algorithm 124 generates a multi-point force distribution change map 110 based on the force distribution detected at two or more points in time for recognizing the gesture. Note that the term “multi-point force distribution change map 110” is a general definition for indicating the change of exerted the normal force on each force-sensing point 108a-c over time, and it may be expressed, shown or stored in either graph type (such as map or chart) or non-graph type (such as data array, mathematical expressions, data model, or one or more force distribution conditions of a gesture, et cetera.) In addition, the multi-point force distribution change map 110 is defined by at least two parameters. These parameters of multi-point force distribution change map 110 include force value parameter, force-sensing point coordinate parameter 112b, time parameter, and any other parameters derived from force-sensing point coordinate 112b, force value and time, such as force change value parameter 112a, force change level parameter, force change rate parameter, or force change trend parameter. For the sake of brief explanation, hereafter the force change value parameter 112a, force change level parameter, force change rate parameter, and force change trend parameter are called “force change parameter. As an example for explanation, a multi-point force distribution change map 110, as shown in FIG. 3, is defined by force change value parameter 112a and force-sensing point coordinate parameter 112b, and it is shown as a three-dimensional column chart. As another example, a multi-point force distribution change map 110 in FIG. 5, 7, 9 is shown as a pressure contour map. In some embodiments, a dynamic multi-point force distribution map is defined by at least three parameters including force-sensing point coordinate parameter, time parameter and force parameter/force change parameter is also a type of multi-point force distribution change map 110.

In some embodiments, a multi-point force distribution change map 110 may further indicate some key features associated to the gesture, hereafter called “gesture-related features,” and these features may be used as parameters of gesture-based or gesture-and-motion-based instructions. These gesture-related features include gesture body part, gesture force level, gesture force direction, gesture force change trend or rate, gesture frequency over time (hereafter called gesture frequency), gesture time, and contact angle or contact area between a force-sensing garment 1150 and an external surface. In the multi-point force distribution change map 110 in FIG. 3, if both force change value 114a of force-sensing point 108a and force change value 114b of force-sensing point 108b are zero, it indicates that the normal force exerted on either force-sensing point 108a or force-sensing point 108b does not be changed. During a process of gesturing with a hand 200a covered by the force-sensing glove 102a, a highlighted region of the multi-point force distribution change map 110 including greater force change values 114a-b and greatest force change values 116a-c indicates that the normal force exerted on some of the force-sensing points 108a-c is increasing, and some of the force-sensing areas are deformed.

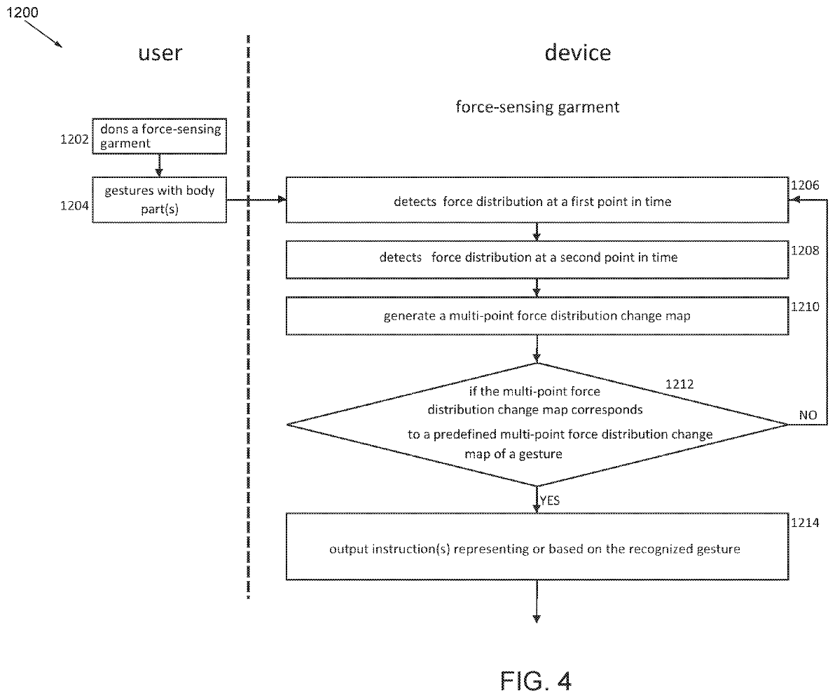

FIG. 4 is a flow diagram illustrating a process 1200 for recognizing gestures through a multi-point force distribution change map 110 and further generating gesture-based instructions, in accordance with an embodiment of the present invention. The process 1200 includes a step 1202 of that a user dons a force-sensing garment 1150 comprising multiple discrete force-sensing points 108a-c, a step 1204 of that the user gestures with a body part covered by the force-sensing garment 1150, a step 1206 of that the force sensing-sensing garment 1150 detects force distribution at a first point in time, a step 1208 of that the force-sensing garment 1150 detects force distribution at a second point in time, a step 1210 of that a program or algorithm 124 of gesture module 1132 generates a multi-point force distribution change map 110 based on the detected force distribution of at least two points in time. If the multi-point force distribution change map 110 corresponds to a predefined multi-point force distribution change map 110 of a gesture (step 1212—Yes), the device 1100 outputs instructions representing or based on the gesture (step 1214). If the multi-point force distribution change map 110 does not correspond to a predefined multi-point force distribution change map 110 of a gesture (Step 1212—No), the device 1100 turns back to the step 1206 to detect force distribution at next point in time. Note that the term of “correspond”, for recognizing gestures by analyzing or compare the multi-point force distribution change maps, may not only mean that the generated multi-point force distribution change map is same to a predefined multi-point force change map of a gesture, it also may mean that the generated multi-point force distribution change map is satisfied one of more force distribution change conditions of performing a gesture.

In one embodiment, the device 1100 may recognize the gesture by two or more multi-point force distribution change maps 110 of different points in time. In this case, the process 1200 may include steps further generating one or two more multi-point force distribution change maps 110 based on force distribution of at least two later points in time and analyzing the multi-point force distribution change maps 110 to recognize the gesture.

In some embodiments, some gesture-related features, indicated or recognized by a program or algorithm 124 analyzing the one or more multi-point force distribution change maps 110, are used to present some properties of an interaction object or application. In this condition, step 1214 may further include transmitting a multi-point force distribution map 110 into values of one or more properties of an interaction object or application, and generating gesture-based instructions.

In some embodiments, the gesture-based instructions are based only on the recognized gesture. Though in other embodiments, the gesture-based instructions are based on the recognized gesture, gesture body part, and one or more other gesture-related features. More details for instructions based on gestures and gesture-related features will be shown in description for FIG. 10.

In another embodiment, a process 1300 (not shown in the FIGs) for recognizing user identity is like process 1200 for recognizing gestures through a multi-point force distribution change map 110. The process 1300 include steps 1202, 1204, 1206, 1208, 1210 described in process 1200, and step 1213 (not shown in FIGs), if the multi-point force distribution change map 110 corresponds to a predefined multi-point force distribution change map 110 of a gesture of a user (step 1213—Yes), the device 1100 outputs instructions representing or based on the user identity (step 1215, not shown), if the multi-point force distribution change map 110 does not correspond to a predefined multi-point force distribution change map 110 of a gesture of a user (step 1213—No), the device 1100 turns back to step 1206 to detect force distribution of next point in time.

FIG. 5 illustrates a force-sensing glove 102a, a hand 200a and a multi-point force distribution change map 110 in a user recognition mode, in accordance with an embodiment of the present invention. Generally, Body part contours are distinguishing biological traits of users. For example, the size and contour of each user's hands or fingers are different and have unique features. When a user dons the force-sensing glove 102a on a hand 200a and makes a gesture, there are multiple contact areas between an inner surface of the force-sensing glove 102a and the skin surface of the user's hand 200a. At the same time, there are multiple deformation areas of the force-sensing glove 102a. Simultaneously, the normal force exerted on each force-sensing point 108a, 108b, 108c are changed by contact and/or deformation, and the change results in a unique multi-point force distribution change map 110. In the embodiment as shown in FIG. 5A, a user dons a force-sensing glove 102a on a hand 200a, and makes a gesture of pressing palm on a flat surface as shown in FIG. 5B, when the force distribution is changed, a multi-point force distribution change map 110 of palm area, as shown in FIG. 5C, is generated for recognizing user identity.

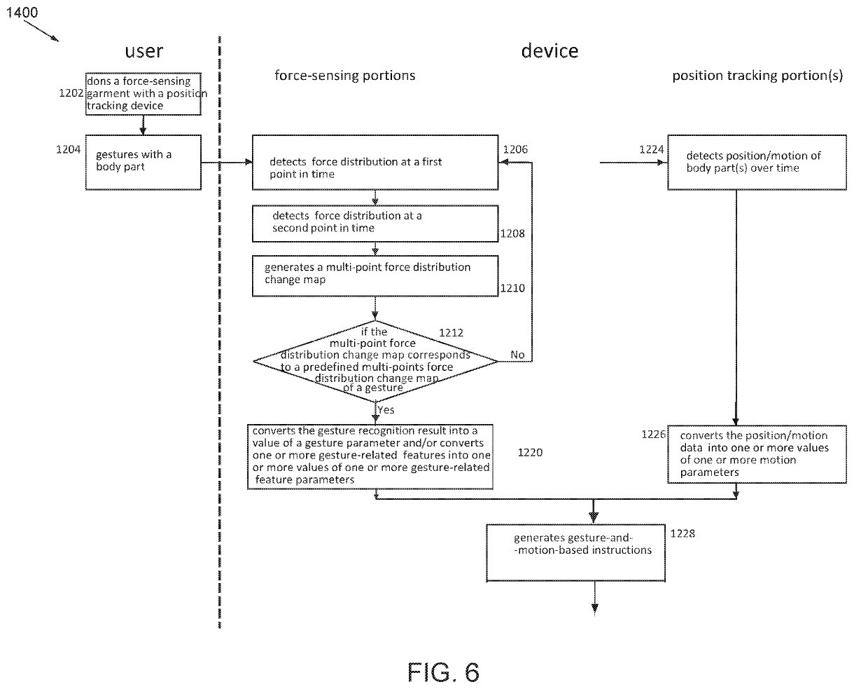

FIG. 6 is a flow diagram illustrating a process 1400 for generating gesture-and-motion-based instructions, in accordance with an embodiment of the present invention. The process 1400 includes steps for gesture recognition, steps for motion detection, and steps for converting recognized gesture and motion into gesture-and-motion-based instructions. The steps for gesture recognition includes a step 1202 of that a user dons a force-sensing garments 1150 with a position tracking device 1160, a step 1204 of that the user gestures with a body part covered by the force-sensing garment 1150, a step 1206 of that the force-sensing garment 1150 detects force distribution at a first point in time, a step 1208 of that the force-sensing garment 1150 detects force distribution at a second point in time, a step 1210 of that a program or algorithm 124 of gesture module 1132 generates a multi-point force distribution change map 110 based on the detected force distribution of at least two points in time, if the multi-point force distribution change map 110 corresponds to a predefined multi-point force distribution change map 110 of a gesture (step 1212—Yes), the device 1100 converts the gesture into a value of gesture parameter (step 1220), if the multi-point force distribution change map 110 does not correspond to a predefined multi-point force distribution change map 110 of a gesture (Step 1212—No), the device 1100 turns back to detect force distribution of a next point in time (step 1206). The steps for motion detection include a step 1224 of that a position tracking device 1160 detects position/motion of a body part over time, and a step 1226 of that a program or algorithm of motion module 1133 converts the detected position/motion into one or more values of one or more motion parameters. The steps for generating gesture-and-motion-based instructions include a step 1228 of that a program or algorithm of an application 1134 generates instructions based on the values of gesture parameter and one or more motion parameters. Note that the gesture parameter means what gesture a user performs, and a recognized gesture or instructions representing the gesture may be used as a value of gesture parameter.

In some embodiments, step 1220 may further include converting the multi-point force distribution change map 110 into values of gesture-related feature parameters. The step 1228 of that the device 1100 generates instructions based on the values of gesture parameter, one or more motion parameters and one or more gesture-related feature parameters. More details for instructions based on gesture parameter, gesture-related feature parameters, and motion parameters are shown in description of FIG. 10.

In step 1202 of the process 1400, the position tracking devices 1160 is integrated into or attached to the force-sensing garment 1150. Though in some embodiments, the one or more position tracking devices 1160 may be separated from the force-sensing garment 1150.

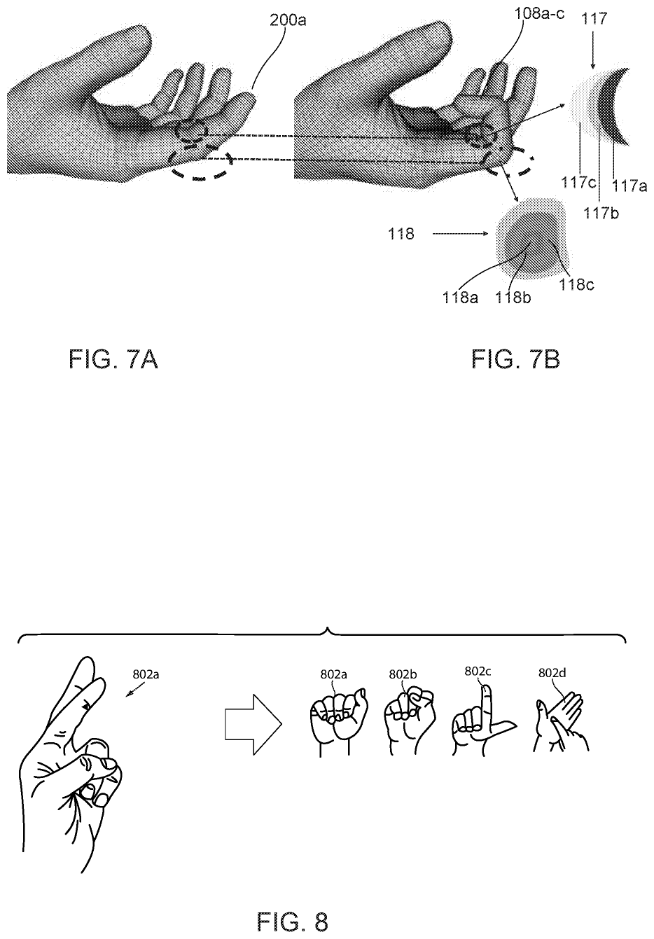

FIG. 7 illustrates an example of force distribution change on some certain areas of a force-sensing garment 1150 during a process of gesturing with a body part. For example, FIG. 7A shows a hand 200a wearing a force-sensing glove 102a at a first point in time. FIG. 7B shows the hand 200a wearing the force-sensing glove 102a at a second point in time. During the process of closing a forefinger (from FIG. 7A to FIG. 7B), on the inner side area of proximal interphalangeal joint, the contact between the forefinger and the inner surface of the force-sensing glove 102a is changed, and therefore the force distribution on the contact area is changed. At the same time, on the outer side area of proximal interphalangeal joint, the force-sensing glove 102a surface is stretched, and the stretch causes the force distribution of the stretch area to be changed. In a generated multi-point force distribution change map 110, the highlighted region 117 corresponding to the contact area and the highlighted region 118 correspondings to the stretch area, as shown in FIG. 7B, indicate that the force distribution of these areas are changed. In the highlighted region 117, there are three force levels areas, wherein 117c represents a regular pressure level area, 117b represents a higher-pressure level area, 117a represents the highest-pressure level area. In the highlighted region 118, there are more than three pressure levels, wherein 118a represents the highest-pressure level area, 118b represents a higher-pressure level area, 118c represents a regular pressure level area. FIG. 8 illustrates a consistent one-to-one match relation between gesture, body part, contact area, and multi-point force distribution change map 110 when a user performs different gestures, in accordance with an embodiment of the present invention. For instance, when a user wearing a force-sensing glove 102a makes a good luck hand gesture 802, there are multiple contact areas, such as the contact area between back side of forefinger and front side of middle finger, the contact area between thumb and ring finger, and the contact area between ring finger and pinky finger. While the user changes gesture 802 to sign language letter A gesture 802a, there are multiple contact areas between fiver gingers and palm. In the same way, when the user makes gestures 802b, 802c, and 802d, the gestures 802b-d correspond to different contact areas, different gesture body parts, and different multi-point force distribution change maps 110. Vice versa, each multi-point force distribution map 110 corresponds to a gesture, contact areas, and gesture body part(s). According to the consistent one-to-one match relation between gesture, body part, contact area and multi-point force distribution change map 110, the gesture body part is identified by analyzing a multi-point force distribution change map 110, and it may further be converted into a value of body part parameter of gesture-based or gesture-and-motion-based instructions.

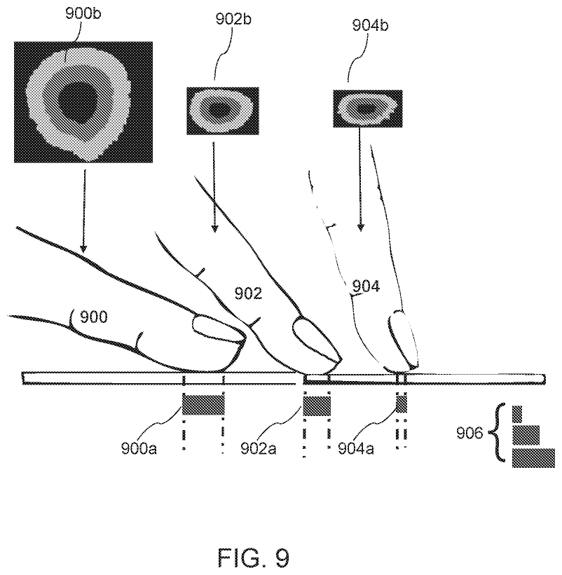

FIG. 9 illustrates a consistent one-to-one match relation between contact area, contact angle, and multi-point force distribution change map 110, in accordance with an embodiment of the present invention. As showed in FIG. 9, a user wearing a force-sensing glove 102a uses a finger to perform gestures of taping on an external flat surface in different angles. When the user taps on the external flat surface in a proximate thirty-degree angle 900, there is a relatively large contact area 900a between the fingertip area of the force-sensing glove 102a and the external flat surface, and a multi-point force distribution change map 110 of the contact area is generated as 900b. When the user taps on the external flat surface in a proximate forty-five-degree angle 902, there is a relatively small contact area 902a between the fingertip area of the force-sensing glove 102a and the external flat surface, and a multi-point force distribution change map 110 of the contact area is generated as 902b. When the user taps on the external flat surface in a near nighty degree angle 904, there is a smaller contact area 904a between the fingertip area of the force-sensing glove 102a and the external flat surface, and a multi-point force distribution change map 110 of the contact area is generated as 904b. The difference of contact areas 900a, 902a, 904a can be compared and shown as 906, and the difference of multi-point force distribution change maps 110 are easy to be understood as shown in 900b, 902b, and 904b. Based on the consistent one-to-one match relation between contact area, contact angle and multi-point force distribution change map 110, the proximate contact angle or contact area between a force-sensing garment 1150 and an external contact surface is identified by analyzing the multi-point force distribution change map 110, and it may further be converted into a value of contact angle parameter or contact area parameter of gesture-based or gesture-and-motion-based instructions.

In the same way, other gesture-related features such as gesture force level, gesture force direction, gesture force change trend or rate, gesture frequency over time and gesture lasting time may be identified by analyzing one or more multi-point force distribution change maps 110.

FIG. 10 illustrates examples of a user's gestures and rules of generating gesture-based instruction or gesture-and-motion-based instructions, in accordance with some embodiments of the present invention. For example, in FIG. 10A, there are three groups of parameters, including gesture parameter, gesture-related feature parameters, and motion parameters. The gesture-related features include gesture body part, gesture force value, gesture force level, frequency of a gesture over time (gesture frequency), the time of holding a gesture (hereafter called “gesture time”), contact area or angle between a body part and an external surface. Some specific options or values of these gesture-related features may be converted into values of gesture-related feature parameters. The motion parameters include position parameter (x₆), motion direction parameter (x₇), motion path parameter (x₈), motion range parameter, and motion speed parameter (x₉).

In examples described below, the conversion of gesturing into gesture-based or gesture-and-motion-based instructions is expressed as y=f(x₁, x₂, x₃, . . . , xₙ). Wherein the “y” represents gesture-based or gesture-and-motion-based instructions, and the “x₁, x₂, x₃, . . . , xₙ” represent variable parameters.

In examples 1-9, The gesture body part parameter is represented by x₁, and the options of x₁ include: left thumb, left index finger, left middle finger, left ring finger, left pinky finger, right thumb, right index finger, right middle finger, right ring finger or right pinky finger. In the case of gesturing with two or three body parts, the body part parameter is expressed as x₁+x₁ or x₁+x₁+x₁, respectively. The gesture parameter is represented by x₂, and the options of x₂ include knock, press, tap, slide, strike, push, and pull. The gesture force level parameter is represented by x₃, and the options of x₃ include light, medium, and firm. The gesture time parameter is represented by x₄, and the options of x₄ include three seconds, five seconds and ten seconds. The gesture frequency parameter is represented by x₅, and the options of x₅ include once, double and triple. The position parameter is represented by x₆, and the options of x₆ include values of x-coordinate, y-coordinate, and z-coordinate. The motion direction parameter is represented by x₇, and the options of x₇ include left, right, front, back, up and down. The motion path parameter is represented by x₈, and the options of x₈ include path P, path Q and path W. The motion speed parameter is represented by x₉, and the options of x₉, include fast and slow.

Note that the options or values of these parameters are only examples for explaining and illustration, and it does not mean there are only these options or values. Depending on the complexity of gestures, instruction needs, and gesture capacity of body part, a user may change or optimize the options or values of parameters in different ways.

In example 1 of FIGS. 10A and 10B, a user uses left hand donning a force-sensing glove 102a to make a gesture of pressing left index finger on a flat surface for performing an operation such as to input letter A. The generated instruction (y=A) is based on gesture body part parameter (x₁=left index finger) and gesture parameter (x₂=press), and the conversion is expressed as y=f(x₁, x₂).

In example 2 of FIGS. 10A and 10B, the user uses left hand donning the force-sensing glove 102a to make a gesture of lightly pressing left index finger on a flat surface for performing an operation such as to input two letters, A and B. The generated instruction (y=AB) is based on gesture body part parameter (x₁=left index finger), gesture parameter (x₂=press), and gesture force level parameter (x₃=light), and the conversion is expressed as y=f(x₁, x₂, x₃).

In example 3 of FIGS. 10A and 10B, the user uses left hand donning the force-sensing glove 102a to make a gesture of lightly pressing left index finger on a surface for three seconds for performing an operation such as to input three letters, A, B and C. The generated instruction (y=ABC) is based on gesture body part parameter (x₁=left index finger), gesture parameter (x₂=press), gesture force level parameter (x₃=light), and gesture time parameter (x₄=3S), and the conversion is expressed as y=f(x₁, x₂, x₃, x₄).

In example 4 of FIGS. 10A and 10B, the user uses left hand donning the force-sensing glove 102a to make a gesture of lightly pressing left index and middle fingers for three seconds for performing an operation such as to input four letters A, B, C and D. The generated instruction (y=ABCD) is based on gesture body part parameter (x₁+x₁=left index finger and middle finger), gesture parameter (x₂=press), gesture force level parameter (x₃=light), and gesture time parameter (x₄=3S), and the conversion is expressed as y=f(x₁+x₁, x₂, x₃, x₄)

In example 5 of FIGS. 10A and 10B, the user uses left hand donning the force-sensing glove 102a to make a gesture of lightly pressing left index, middle and ring finger for three seconds on a flat surface for performing an operation such as to input five letters A, B, C, D and E. The generated instruction (y=ABCDE) is based on gesture body part parameter (x₁+x₁+x₁=left index finger, middle finger and ring finger), gesture parameter (x₂=press), gesture force level parameter (x₃=light), and gesture time parameter (x₄=3S), and the conversion is expressed as y=f(x₁+x₁+x₁, x₂, x₃, x₄).

In example 6 of FIGS. 10A and 10B, the user uses left hand donning the force-sensing glove 102a to make a gesture of lightly pressing left index, middle and ring fingers and moving along Path P on a flat surface for performing an operation such as to input six letters A, B, C, D, E and F. The generated instruction (y=ABCDEF) is based on gesture body part parameter (x₁+x₁+x₁=left index finger, middle finger and ring finger), gesture parameter (x₂=press and move), gesture force level parameter (x₃=light) and motion path parameter (x₈=Path P), and the conversion is expressed as y=f(x₁+x₁+x₁, x₂, x₃, x₈).

In example 7 of FIGS. 10A and 10B, the user uses left hand donning the force-sensing glove 102a to make a gesture of lightly pressing left index, middle and ring finger and moving fast along Path P for performing an operation such as to input seven letters A, B, C, D, E, F and G. The generated instruction (y=ABCDEFG) is based on gesture body part parameter (x₁+x₁+x₁=left index finger, middle finger and ring finger), gesture parameter (x₂=press and move), gesture force level parameter (x₃=light), motion path parameter (x₈=Path P) and motion speed parameter (x₉=slow), and the conversion is expressed as y=f(x₁+x₁+x₁, x₂, x₃, x₈, x₉).

Note that these examples are just illustrations of converting gesturing into gesture-based or gesture-and-motion-based instructions, the specific rules of converting gesturing into gesture-based or gesture-and-motion-based instructions may be different in other embodiments.

In some embodiments, one parameter represents one property of an interaction object or application, and an option or value of a parameter may be converted into a property value of the interaction object or application. In the same way, multiple parameters may represent multiple properties of an interaction object or application, and the specific values or options of multiple parameters may be converted some values of properties of the interaction object or application. In these ways, the device 1100 including a force-sensing garment 1150 may generate complex gesture-based or gesture-and-motion based instructions by a simple gesture operation.

In one embodiment, the device 1100 including force-sensing gloves acts as a wearable keyboard. Though in another embodiment, the device 1100 with force-sensing gloves acts as a control center of multiple devices.

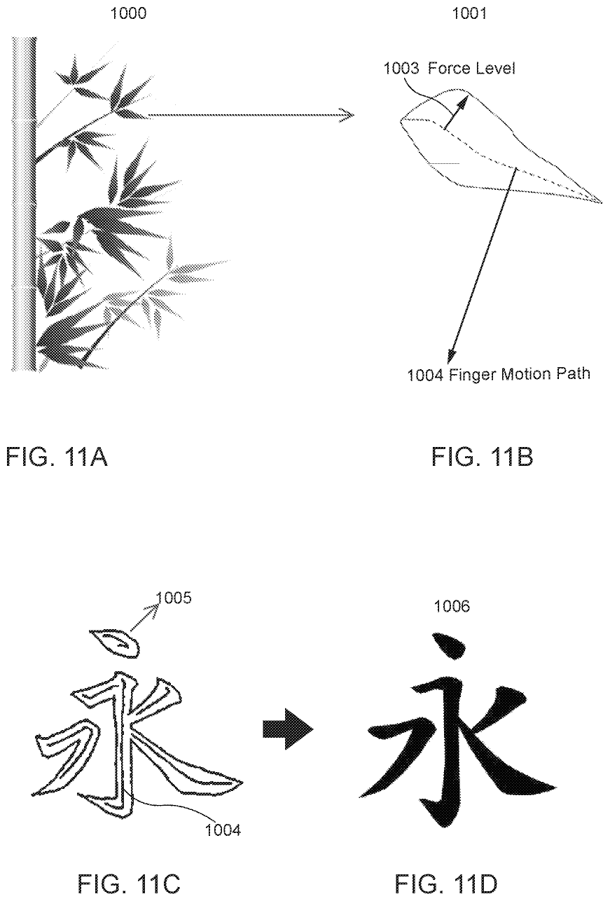

FIGS. 11A-D illustrate some application examples of gesture-and-motion-based instructions. In FIG. 11A, a painted bamboo 1000 is the desired art effect. Usually, for painting a bamboo leaf by a traditional software application, a user needs to choose a brush tool or stylus to outline a leaf shape 1001, then the user selects a color to fill the outline. The process of choosing different kinds of tools and switching between options of tools are very complicated and tedious. However, by gesture-and-motion-based instructions, it is very easy to be achieved. For example, in FIG. 11B, a user donning a force-sensing glove 102a with a motion sensor 1160 makes a gesture of sliding a fingertip along a path 1004 on an external flat surface while applying different levels of force 1003 on fingertip area. The gesture, gesture body part and gesture force are recognized by gesture module 1133, and motion path 1004 is detected by motion sensor 1160, then a program or algorithm converts the recognized body part, gesture, gesture force value 1003 and motion path 1004 into values of gesture parameter, body part parameter, gesture force level parameter, and motion parameter, and then a painting program 1134 of device 1100 converts these values of parameters of gesture-and-motion-based instructions into desired bamboo leaf effect 1000. For example, the gesture parameter represents line type property, and different gestures are converted into different types of line; Force value parameter represents line thickness property, and the gesture force value is converted thicker or thinner line; Gesture body part parameter represents color property, and then a combination of multiple body parts of gesturing is converted into mix of different colors. In this way, multiple steps of choosing, switching and using tools are done by one step of gesturing while moving.

FIG. 11C-D is an example of a handwriting application of gesture-and-motion instructions. The process and rules of converting gesture and motion into a desired handwriting effect 1006 are like the painting application described above. In this example, a user donning a force-sensing glove 102a makes a gesture of sliding a fingertip along a path 1004 on an external flat surface while applying different levels of force on fingertip area, then the device 1100 recognizes the gesture, gesture-related features, and motion features, and then a software handwriting application 1134 convert values of gesture parameter, gesture body part parameter, gesture force level parameter and motion path parameter of gesture-and-motion-based instructions into desired handwriting effect 1006. In this example, the Chinese character outline 1005 in FIG. 11C is converted from values of gesture parameter, gesture force value 1003 parameter and motion path 1004 parameter, and the fill color is converted from value of gesture body part parameter, then the Chinese character shape outline 1005 and fill color are further converted into the desired handwriting effect 1006.

Although the flow diagrams 1200, 1300, and 1400 show a specific order of executing the process steps, the order of executing the steps may be changed relative to the order shown in certain embodiments. Also, two or more steps shown in succession may be executed concurrently or with partial concurrence in some embodiments. Certain steps may also be omitted from the flow diagrams for the sake of brevity. In some embodiments, some or all the process steps shown in the process-flow diagrams may be combined into a single step.

These and other advantages of the invention will be further understood and appreciated by those skilled in the art by reference to the following written specification, claims, and appended drawings.

Because many modifications, variations, and changes in detail may be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for recognizing gestures through an electric device including at least one force-sensing garment, the force-sensing garment comprising multiple discrete force-sensing points, the method comprising:
donning a force-sensing garment on a body part;
gesturing with the body part covered by some force-sensing points;
detecting a normal force exerted on each force-sensing point at different points in time;
generating a multi-point force distribution change map based on detected force distribution of the at least two different points in time, wherein the multi-point force distribution change map is defined by at least two parameters including force-sensing point coordinate parameter and force parameter/force change parameter; and
generating instructions representing or based on the gesture if the generated multi-point force distribution change map corresponds to a predefined multi-point force distribution change map of a gesture.

2. The method of claim 1, wherein the force-sensing garment is selected from a group consisting of force-sensing glove, force-sensing wrist band, force-sensing jacket, force-sensing shoe, force-sensing sock, force-sensing pants, and force-sensing thigh sleeve, or one or more portions of these force-sensing garments.

3. The method of claim 1, wherein the multi-point force distribution change map is defined by at least three parameters, including force-sensing point coordinate parameter, time parameter, and force parameter/force change parameter.

4. An electric device, comprising:
one or more force-sensing garments, the force-sensing garment comprising multiple discrete force-sensing points;
memory; one or more processors; and
one or more modules stored in the memory and configured for execution by the one or more processors, the one or more modules comprise instructions:
to detect a normal force exerted on each force-sensing point at different points in time;
to generate a multi-point force distribution change map based on the detected force distribution of at least two different points in time, wherein the multi-point force distribution change map is defined by at least two parameters including force-sensing point coordinate parameter and force parameter/force change parameter;
to generate instructions representing or based on the gesture if the generated multi-point force distribution change map corresponds to a predefined multi-point force distribution change map of a gesture.

5. The electric device of claim 4, further comprising instructions to generate instructions representing or based on the user identity if the generated multi-point force distribution change map corresponds to a predefined multi-point force distribution change map of a gesture of a user.

6. The electric device of claim 4, further comprising instructions to convert the multi-point force distribution change map into gesture-based instructions based on gesture parameter, and one or more gesture-related feature parameters, wherein the gesture-related feature parameters include: gesture body part parameter, gesture force level parameter, gesture force value parameter, gesture force direction parameter, gesture force change trend parameter, gesture force change rate parameter, gesture frequency parameter, gesture time parameter, gesture contact angle parameter, and gesture contact area parameter.

7. The electric device of claim 6, further comprising instructions to convert the values of gesture parameter and gesture-related parameter of gesture-based instructions into property values of an interaction object or application, wherein each parameter corresponds to a property of an interaction object or application.

8. The electric device of claim 6, further comprising one or more position tracking devices to detect the position or motion of the gesture body part;

9. The electric device of claim 8, further comprising instructions to generate gesture-and-motion-based instructions based on gesture parameter, one or more gesture-related parameters, and one or more motion parameters, wherein the motion parameters include position parameter, motion direction parameter, motion path parameter, motion speed parameter, and motion range parameter.

10. The electric device of claim 9, further comprising instructions to convert the values of parameters of gesture-and-motion-based instructions into values of properties of an interaction object or application, wherein each parameter of the gesture-and-motion-based instructions corresponds to a property of an interaction object or application.

11. The electric device of claim 4, wherein the force-sensing garment is selected from a group consisting of force-sensing glove, force-sensing wrist band, force-sensing jacket, force-sensing shoe, force-sensing sock, force-sensing pants, and force-sensing thigh sleeve, or one or more portions of these force-sensing garments.

12. A computer-readable storage medium storing one or more programs, the one or more programs comprising instructions, which when executed by an electronic device with a force-sensing garment comprising multiple discrete force-sensing points, cause the electronic device to perform a method comprising:
detecting a normal force exerted on each force-sensing point at different points in time;
generating a multi-point force distribution change map based on the detected force distribution of at least two points in time, wherein the multi-point force distribution change map is defined by at least two parameters including force-sensing point coordinate parameter and force parameter/force change parameter; and
generating instructions representing or based on the gesture if the generated multi-point force distribution change map corresponds to a predefined multi-point force distribution change map of a gesture.

13. The computer-readable storage medium of claim 12, wherein the method further comprises converting the multi-point force distribution change map into gesture-based instructions, wherein the gesture-based instructions are based on gesture parameter, gesture body part parameter, and one or more other gesture-related feature parameters, wherein the other gesture-ralted feature parameters includes: gesture force level parameter, gesture force value parameter, gesture force direction parameter, gesture force change trend parameter, gesture force change rate parameter, gesture frequency parameter, gesture time parameter, gesture contact angle parameter, and gesture contact area parameter.

14. The computer-readable storage medium of claim 13, wherein the method further comprises converting the values of parameters of gesture-based instructions into property values of an interaction object or application, wherein each parameter of gesture-based instructions corresponds to a property of an interaction object or application.

15. The computer-readable storage medium of claim 13, wherein the method further comprises:
detecting position or motion of a body part covered by the force-sensing garment;
converting the position or motion of the body part into one or more values of one or more motion parameters of gesture-and-motion-based instructions; and
generating gesture-and-motion based instructions bases on gesture parameter, one or more gesture-related feature parameters, and one or more motion parameters, wherein the motion parameters include: position parameter, motion direction parameter, motion path parameter, motion speed parameter, and motion range parameter.

16. The computer-readable storage medium of claim 15, wherein the method further comprises converting the values of parameters of gesture-and-motion based instructions into values of properties of an interaction object or application, wherein each parameter of gesture-and-motion-based instructions corresponds to a property of an interaction object or application.

17. A type of gesture-based instructions based on gesture parameter, gesture body part parameter, one or more other gesture-related feature parameters, and one or more motion parameters, wherein the other gesture-related feature parameters include: gesture force level parameter, gesture force value parameter, gesture force direction parameter, gesture force change trend parameter, gesture force change rate parameter, gesture frequency parameter, gesture time parameter, gesture contact angle parameter, and gesture contact area parameter, wherein the motion parameters include: position parameter, motion direction parameter, motion path parameter, motion speed parameter, and motion range parameter.
